(19) United States
(12) Patent Application Publication
(10) Pub. No.: US 2014/0330741 A1
(43) Pub. Date: Nov. 6, 2014

(54) DELIVERY ESTIMATE PREDICTION AND VISUALIZATION SYSTEM

(71) Applicants: Iwona Bialynicka-Birula, Redmond, WA (US); Maxim Stepin, Redmond, WA (US); Muhammad Arif Iqbal, Bellevue, WA (US); Benjamin Sidhom, Tacoma, WA (US)

(72) Inventors: Iwona Bialynicka-Birula, Redmond, WA (US); Maxim Stepin, Redmond, WA (US); Muhammad Arif Iqbal, Bellevue, WA (US); Benjamin Sidhom, Tacoma, WA (US)

(21) Appl. No.: 14/138,028

(22) Filed: Dec. 21, 2013

Related U.S. Application Data
(60) Provisional application No. 61/819,327, filed on May 3, 2013.
(60) Provisional application No. 61/866,959, filed on Aug. 16, 2013.

(51) Int. Cl. G06Q 10/08

(52) U.S. Cl. CPC G06Q 10/0838
USPC 705/341

(57) ABSTRACT

A first delivery estimate prediction model and a second delivery estimate prediction model are generated using historical data from an online marketplace. Transaction information related to an item listed in the online marketplace is determined. A first time estimate is calculated by applying the transaction information to the first delivery estimate prediction model. A second time estimate is calculated by applying the transaction information to the second delivery estimate prediction model. A delivery time estimate is generated based on the lowest of the first time estimate and the second time estimate.

### CROSS-REFERENCE TO RELATED APPLICATIONS

This application claims the benefit of U.S. Provisional Application No. 61/819,327, filed May 3, 2013, entitled “DELIVERY ESTIMATE PREDICTION SYSTEM,” and U.S. Provisional Application No. 61/866,959, filed Aug. 16, 2013, entitled “PROBABILISTIC DELIVERY ESTIMATES”, which are incorporated herein by reference in their entirety.

### TECHNICAL FIELD

This application relates generally to the field of computer technology and, in a specific example embodiment, to a system and method for a delivery estimate prediction.

### BACKGROUND

Websites provide a number of publishing, listing, and price-setting mechanisms whereby a publisher (e.g., a seller) may list or publish information concerning items for sale. Once a buyer places an order for an item, the seller fulfills the order by shipping the item to the buyer.

The buyer, eager to receive the item, is provided a time range estimate that typically spans from several days to a week. Broad and inaccurate shipping delivery estimates can create frustration in the buyer due to not knowing when exactly to expect receipt of the item. Such an experience also can result in the buyer reducing purchases from the seller and reducing visits to the publisher.

### BRIEF DESCRIPTION OF THE DRAWINGS

The present description is illustrated by way of example, and not by way of limitation, in the figures of the accompanying drawings in which:

FIG. 1 is a network diagram depicting a network system, according to one embodiment, having a client-server architecture configured for exchanging data over a network;

FIG. 2 is a block diagram depicting various components of a network-based publication system, in accordance with some embodiments;

FIG. 3 is a block diagram depicting various components of a delivery estimate prediction application, in accordance with some embodiments;

FIG. 4 is a flow diagram illustrating an example embodiment of a process for a delivery estimate prediction;

FIG. 5 is a flow diagram illustrating an example embodiment of a method for generating a delivery estimate prediction;

FIG. 6 is a flow diagram illustrating another example embodiment of a method for generating a delivery estimate prediction based on item specifics;

FIG. 7 is a flow diagram illustrating an example embodiment of a method for generating a visualization of delivery estimate prediction;

FIG. 8 is a flow diagram illustrating an example embodiment of a method for generating a visualization of delivery estimate prediction for each set of shipping services, carriers, or sellers;

FIG. 9 is a flow diagram illustrating an example embodiment of a method for generating a visualization of a comparison of delivery estimate predictions for one or more shipping services, carriers, or sellers;

FIG. 10 is a graph illustrating an example embodiment of a visualization of delivery estimate prediction;

FIG. 11 is a graph illustrating an example embodiment of a visualization of a comparison of delivery estimate predictions based on shipping carriers;

FIG. 12 is a graph illustrating an example embodiment of a visualization of a comparison of delivery estimate predictions based on sellers;

FIG. 13 shows a diagrammatic representation of a machine in the example form of a computer system within which a set of instructions may be executed to cause the machine to perform any one or more of the methodologies discussed herein; and

FIG. 14 is a graph illustrating an example of accuracy and coverage at different thresholds.

### DETAILED DESCRIPTION

Although the embodiments have been described with reference to specific example embodiments, it will be evident that various modifications and changes may be made to these embodiments without departing from the broader spirit and scope of the description. Accordingly, the specification and drawings are to be regarded in an illustrative rather than a restrictive sense.

Shipping and processing historical data from an online marketplace are used to generate at least two delivery estimate prediction models. Transaction information related to an item listed in the online marketplace is determined. A first time estimate is calculated by applying the transaction information to a first delivery estimate prediction model based on a p model prediction algorithm. A second time estimate is calculated by applying the transaction information to the second delivery estimate prediction model based on a Naïve Bayes classification algorithm. A delivery time estimate for the item is then generated based on the lowest of the first time estimate and the second time estimate.

The transaction information may include, for example, a seller identification, a method of shipment, a shipping origin location of the item, a shipping destination location of the item, an order date and time of the item, and a price of the item. The delivery time estimate represents the maximum number of business days for shipping and handling.

The historical data may include, for example, seller identifications, corresponding methods of shipment, corresponding shipping origin location of items, corresponding shipping destination locations of items, corresponding order dates and times of items, and corresponding prices of items.

The delivery estimate prediction module may also include an item location prediction module that predicts a shipping origin location of the item based on an identification of the seller.

The first delivery estimate prediction model predicts the lowest number of business days x such that a shipping origin location of the item is known, a seller of the item has at least one transaction with tracking information during a training period of the first delivery estimate prediction model, the seller has shipped within y business days at least a fraction p of the time during the training period, a combination of a shipping method, a corresponding three-digit zip code origin prefix, a corresponding three-digit zip code destination prefix resulted in at most z days in shipping time at least a fraction p of the time during the training period, wherein x is the sum of y and z, and p is a model parameter specified individually for each possible value of x.

The second delivery estimate prediction model predicts the total handling and shipping time using a Naïve Bayes algorithm trained with variables from an identification of the seller, a shipment method, a distance between an origin and destination zip codes, the first three digits of the destination zip code, an expected payment hour of day, an expected payment date, a leaf category identifier of the item, and a price of the item, the total handling and shipping time is the lowest number of days x such that the confidence that the item arrives within x days from payment is greater or equal than s times the confidence that the item will arrive later, wherein s is a parameter defined individually for each possible value of x.

In one example embodiment, data for the first and second delivery estimate prediction models are stored as a series of key value pairs in the storage device.

In one example embodiment, the delivery estimate prediction module calculates the first time estimate using a p model algorithm before the second time estimate using a Naïve Bayes algorithm.

In one example embodiment, the delivery estimate prediction module includes a multiple additive regression tree module that separates data related to a third delivery estimate prediction model into two data sets comprising a training data set and a validation data set, uses the training data for training the third delivery estimate prediction model, evaluates the third delivery estimate prediction model using the validation data set after adding each decision tree to generate a validation error, iterates the use of the training data and the evaluation of the third delivery estimate prediction model until the validation error stops decreasing or starts increasing, and calculates a third time estimate by applying the transaction information to the third delivery estimate prediction model.

In one example embodiment, the system also includes a graphical visualization module to generate a graphical display of delivery dates and corresponding delivery probabilities.

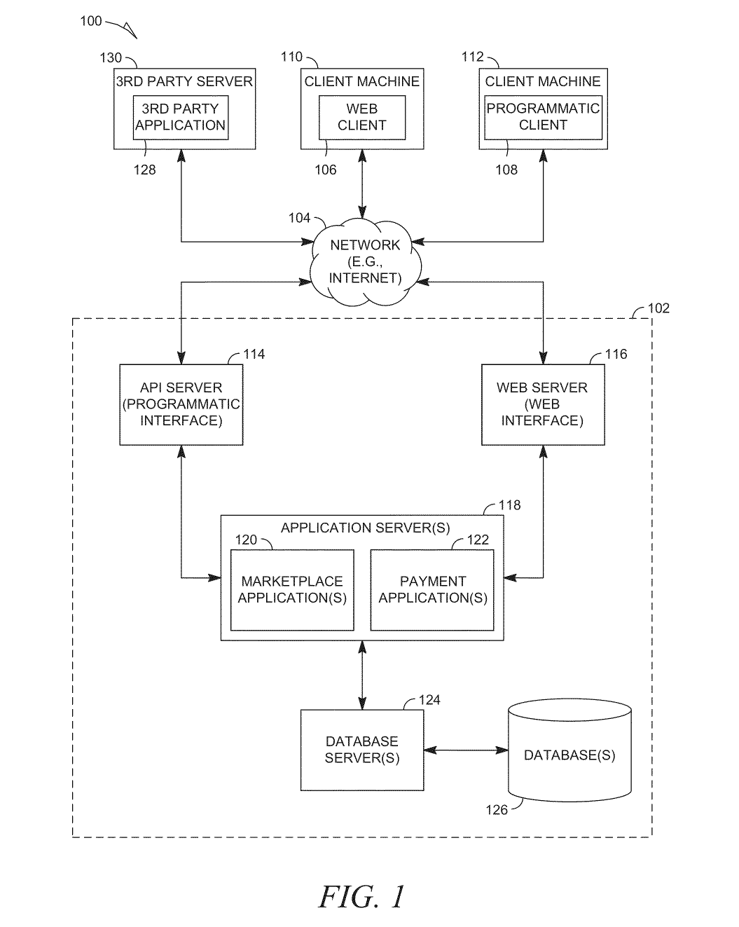

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)) to one or more clients. FIG. 1 illustrates, for example, a web client 106 (e.g., a browser, such as the Internet Explorer browser developed by Microsoft Corporation of Redmond, Wash. State) and a programmatic client 108 executing on respective client machines 110 and 112.

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments are, of course, not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

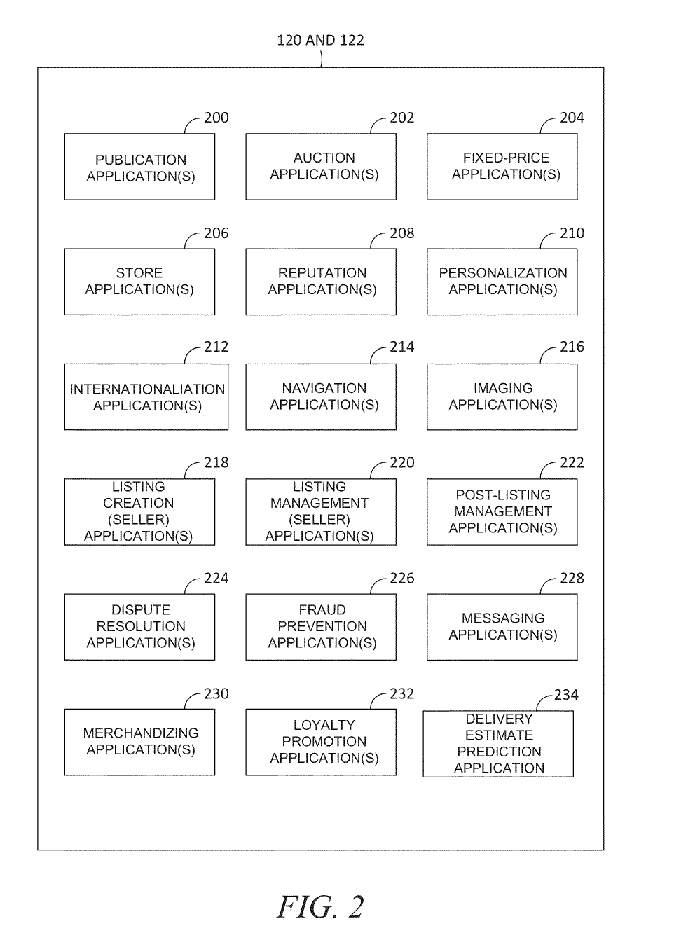

FIG. 2 is a block diagram illustrating multiple applications 120 and 122 that, in one example embodiment, are provided as part of the networked system 102. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may furthermore access one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 120 and 122 are shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example, a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings, available via the networked system 102, as visually informing and attractive as possible, the applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102, such as, for example, messages advising users regarding the status of listings at the networked system 102 (e.g., providing “outbid” notices to bidders during an auction process or to providing promotional and merchandising information to users). Respective messaging applications 228 may utilize any one of a number of message delivery networks and platforms to deliver messages to users. For example, messaging applications 228 may deliver electronic mail (e-mail), instant message (IM), short message service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

A delivery estimate prediction application 234 is responsible for generating and training prediction models for shipping delivery estimates based on the data accumulated by the marketplace application 120 and the payment application 122. The delivery estimate prediction application 234 may generate a shipping delivery estimate based on a combination of the prediction models. The shipping delivery estimate may be a window of time (Monday 1/1 to Wednesday 1/3) or may be a specific date that is the most likely delivery date for an item being ordered by a buyer from a seller on a marketplace application 120. The delivery estimate prediction application 234 may also generate a visualization display for the delivery estimate prediction. For example, a chart or graph may be generated to show the relative probability of shipping delivery for each corresponding day (e.g., 20% chance on Tuesday, 80% chance on Wed, 10% chance on Thursday). The chart or graph may be further manipulated by modifying variables such as method of shipment (express, standard), seller, item, and address.

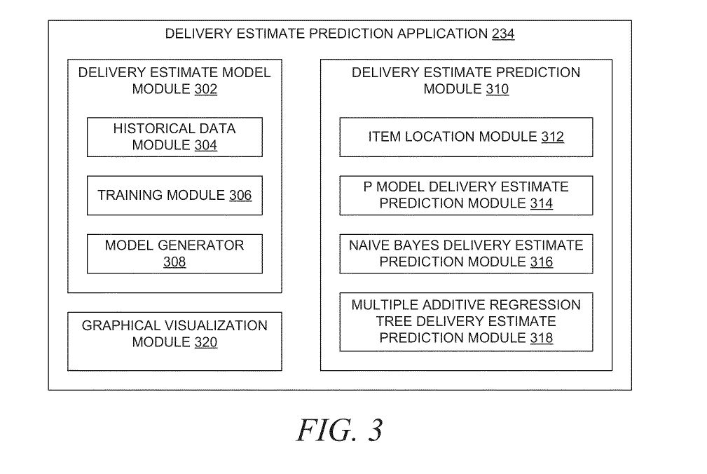

FIG. 3 is a block diagram illustrating an example embodiment of the delivery estimate prediction application 234. In one embodiment, the delivery estimate prediction application 234 includes a delivery estimate model module 302, a delivery estimate prediction module 310, and a graphical visualization module 320.

The delivery estimate model module 302 generates and trains prediction model for shipping delivery estimates based on historical data. In one embodiment, the delivery estimate model module 302 includes a historical data module 304, a training module 306, and a model generator 308.

The historical data module 304 may access historical data from the marketplace application 120 and the payment application 122. For example, the historical data may include:

Id of the seller (long)

Id of the shipment method (int);

Origin zip code (string);

Destination zip code (string);

Payment date and time (date+time);

Leaf category id of the item (long);

Item price (double);

Actual number of handling days observed; and

Actual number of shipping days observed.

The training module 306 may use a distributed file system such as Hadoop to store and process datasets from the historical data. The training module 306 may be further used to train prediction models based on the datasets.

The model generator 308 may be used to generate one or more delivery estimate predication models based on the dataset stored and processed in the training module 306. For example, the model generator 308 may generate a p-model delivery estimate prediction model using the dataset. The output of the model is the lowest numbers of business days x, such that:

The origin zip code is known.

The seller has at least one transaction with tracking information during the training period.

The seller shipped within y business days at least a fraction p of the time during the training period.

The shipping method+three-digit zip origin zip code prefix+three-digit destination zip code prefix resulted in at most z days shipping time at least a fraction p of the time during the training period.

y+z=x

p is a model parameter specified individually for each possible value of x.

In another example, the model generator 308 may generate a Naïve Bayes delivery estimate prediction model using the dataset. The Naïve Bayes prediction model uses a Naïve Bayes algorithm to predict the total handling and shipping time based on the following features:

Id of the seller;

Id of the shipment method;

Distance between the origin and destination zip codes rounded to the nearest 55 km;

First three digits of the destination zip code;

Expected payment hour of day;

Expected payment day of week;

Expected payment month;

Leaf category id of the item; and

Item price rounded to the nearest $10.

The prediction uses a user-defined smoothing factor (default is 1) and ignores features for which the value is unknown. The result is the lowest number of days x such that the confidence that the item arrives within x days from payment is greater or equal than s times the confidence that the item will arrive later, according to the Naïve Bayes algorithm. The parameter s is defined individually for each possible value of x.

The delivery estimate prediction module 310 generates a shipping delivery estimate by applying transaction information related to an item being purchased or ordered in the marketplace application 120 to the prediction models generated by the model generator 308.

For example, the transaction information may include:

The id of the seller (long);

The id of the shipment method (int);

Item location zip code (string);

Destination zip code (string);

Start date and time (date+time), which is the expected payment date—in case of BIN items, it is the current date and time and in case of auction items, the auction end date and time;

Leaf category id of the item (long); and

Item price (double).

The shipping delivery estimate generated by the delivery estimate prediction module 310 may include a maximum number of business days for shipping and handling. In one example embodiment, the delivery estimate prediction module 310 generates a shipping delivery estimate that includes the minimum delivery time returned by a combination of the p model delivery estimate prediction module 314, a Naïve Bayes delivery estimate prediction module 316, and the multiple additive regression tree (MART) delivery estimate prediction module 318.

In another example embodiment, the delivery estimate prediction module 310 may generate a probability of delivery for one or more days in a range of dates.

In one embodiment, the delivery estimate prediction module 310 includes an item location module 312, a p model delivery estimate prediction module 314, a Naïve Bayes delivery estimate prediction module 316, and a multiple additive regression tree (MART) delivery estimate prediction module 318.

The item location module 312 predicts the item location or the shipping origin location, in case the shipping origin location is not known. If the item location zip code is provided, this is what is used as the origin zip code. Otherwise, the origin zip code is predicted by taking the most frequent origin zip code for the given seller. If the seller has no such zip codes associated (e.g., the seller did not ship anything with tracking in the model training period), the Naïve Bayes model may still be applied using no zip code.

The p model delivery estimate prediction module 314 applies the transaction information to the p model delivery estimate prediction model generated in the model generator 308.

The Naïve Bayes delivery estimate prediction module 316 applies the transaction information to the Naïve Bayes delivery estimate prediction model generated in the model generator 308.

The following example configuration parameters may be utilized by the p model delivery estimate prediction module 314 and the Naïve Bayes delivery estimate prediction module 316:

maxDays—the maximum number of days the model will try to make a prediction for;

pValues—an array of parameters p for the p-model predictor for 0, 1, etc. days—for any days which are not defined in this array, the last value from the array is used;

Strictnesses—an array of parameters s for the Naïve Bayes predictor for 0, 1, etc. days—for any days which are not defined in this array, the last value from the array is used;

smoothingConstant—the smoothing constant for the Naïve Bayes predictor;

useSellerZipPrediction—whether or not to perform seller zip prediction;

usePModel—whether or not to use the p-model predictor; and useNaiveBayes—whether or not to use the Naïve Bayes predictor.

Both the p-model and Naïve Bayes models are conceptually composed of separate classification algorithms and each classification algorithm answers the binary question: is the item going to arrive within x days or later. In one example embodiment, the information for all of the different x values is combined together in order to minimize the memory consumption and do the evaluations in a way which maximizes early termination in order to minimize the running time of the algorithm (e.g., prediction estimate algorithm).

In one embodiment, the data for both models as a series of key value pairs, where the key is a feature value (for example DayOfWeek=Saturday) and the value is a histogram of either end-to-end to delivery times in the case of the Naïve Bayes model or separate handling and shipping times in the case of the p-model. The histograms store absolute values, rather than normalized fractions, which enables efficient memory optimization as well as runtime configuration changes. So for example, a value may be represented as follows:

| Number of days | Occurrences |
|---|---|
| 0 | 13 |
| 1 | 738,784 |
| 2 | 557,437 |
| . . . | . . . |
| 20 | 5 |

Occurrence values can run into the millions when using a lot of historical data to train on, so storing all of them in an array can be costly in terms of memory. So, for memory optimization, the histograms are compressed using variable-length encoding. Since this data has a large number of zeroes in it, we additionally reserve a 1-bit code for the zero value.

In one example embodiment, the execution of modules 314 and 316 may be optimized for early termination by using the following scheme. The p-model is evaluated first (since it is faster). Two nested loops loop over every possible combination of handling days and shipping days whose sum is within maxDays. Combinations which would result in a greater estimate than has been already predicted are skipped over. The Naïve Bayes model only evaluates day counts which are strictly less than the result of the p-model. A single loop iterates over all possible end-to-end delivery day counts within maxDays. The loop exits after the first (least number of days) positive classification

It is useful to vary the configuration parameters at runtime without having to regenerate data files, since regeneration takes a long time given the data volumes for making accurate predictions. To that end, a number of computations is performed at runtime:

Computing running sums of the histograms and dividing them by the total;

Applying the smoothing constant; and

Computing log-probabilities for the Naïve Bayes evaluation.

The MART delivery estimate prediction module 318 uses multiple additive regression trees to predict the shipment delivery date. Adding multiple decision trees for prediction outperforms a single decision tree as it help reduces the overall training error. The squared loss between predicted and actual value is minimized.

In one embodiment, the MART delivery estimate prediction module 318 tries to minimize the squared root error between the predicted and actual delivery days. Overall data from the historical data module 304 is separated into two data sets: training data and validation data. The training module 306 trains the model using the training data. The model generator 308 generates a model that is evaluated using the validation data set after adding each tree to ensure over-fitting does not happen. The iteration of adding each tree stops when the validation error is not decreasing anymore or has started increasing.

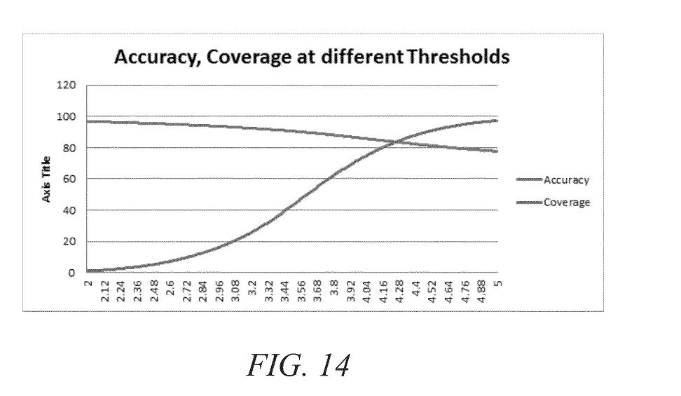

The output of the MART model is a continuous number that is translated into a number of days. For example, a threshold is determined (e.g. any value less 0.8 means predict 1 day, less than 2.1 means predict 2 days). The accuracy and coverage numbers are computed for all possible values for each day. FIG. 14 illustrates an example of a graph of accuracy and coverage numbers at different thresholds. Accuracy represents a percentage of cases that were predicted to be x days and were actually delivered in x days or less. Coverage represents the percentage of cases that were predicted correctly (e.g., total items actually delivered in x days).

The following is one example implementation embodiment: the model training process generates the following data: historical data for seller, location, category and shipment method. One major output is the model itself (e.g., regression trees). A program can take these rules and convert them into code that can be loaded into the online service.

To make the model run on a live site, all the historical files are loaded up at the start time by the service and are stored in memory. The code for the trees is also loaded up at the service start time for making predictions. When the request for a delivery estimate comes in, all the historical signals are first retrieved from our historical data. All the signals are then fed into the model to compute the output score. The score is then compared with the defined thresholds to find the predicted days.

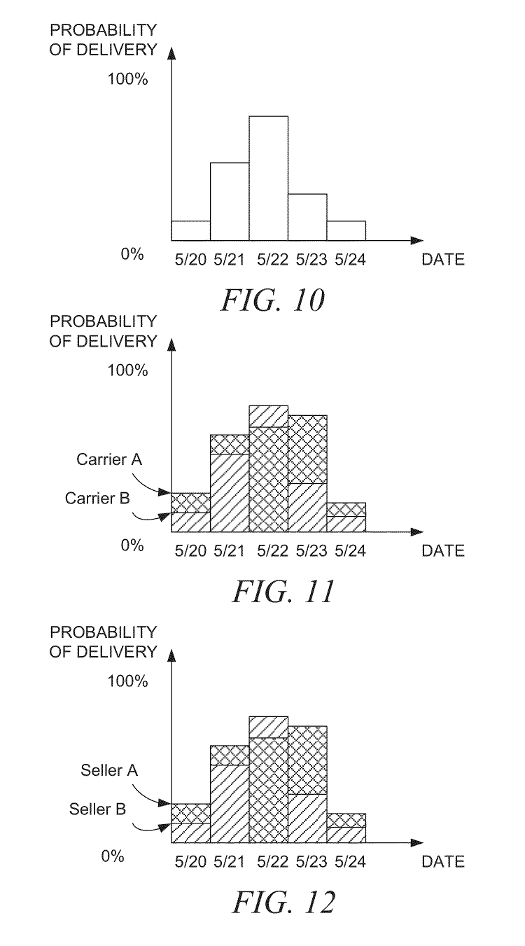

The graphical visualization module 320 generates a visualization display for the delivery estimate prediction generated from the delivery estimate prediction module 310. For example, the visualization display may include a histogram, a calendar, a graph, or a chart that illustrates the probability of delivery on a particular date. FIG. 10 illustrates an example of a delivery probability estimate graph.

In another embodiment, the graphical visualization module 320 can generate a comparison of visualization of delivery probability based on different variables (e.g., different carriers as illustrated in FIG. 11, different sellers as illustrated in FIG. 12).

As such, one goal of the delivery estimate predictive algorithm is to provide delivery estimates in business days based on item and transaction details. In certain aspects, the algorithm works by processing historical data about past transactions and aggregating them into a model file. This file may then be loaded into memory and used to predict delivery times for new transactions in an online fashion.

The delivery estimate models are independent predictors of the delivery time. The output of the algorithm may be the minimum delivery time returned by either predictor. In another example embodiment, the output of the algorithm is a weighted combination of the delivery time returned by the individual predictors (e.g., the arithmetic mean, or a weighted arithmetic mean).

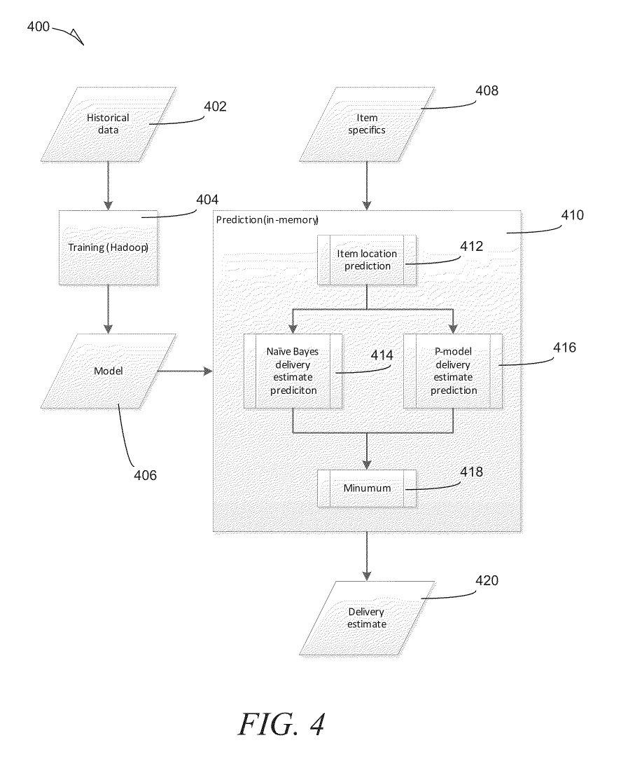

Referring back to FIG. 4, an example embodiment of a process 400 for a delivery estimate prediction is illustrated. At 402, historical data 402 are accessed for training at 404. A model 406 generated from the training is provided to an in-memory prediction module 410. Item specifics 408 are provided to the prediction module 410. For example, the location of an item location is predicted at 412. At least two prediction algorithms are applied: a Naïve Bayes delivery estimate prediction algorithm 414 and a P model delivery estimate prediction algorithm 416. The minimum of the results from the both algorithms is selected at 418 to compute the delivery estimate at 420.

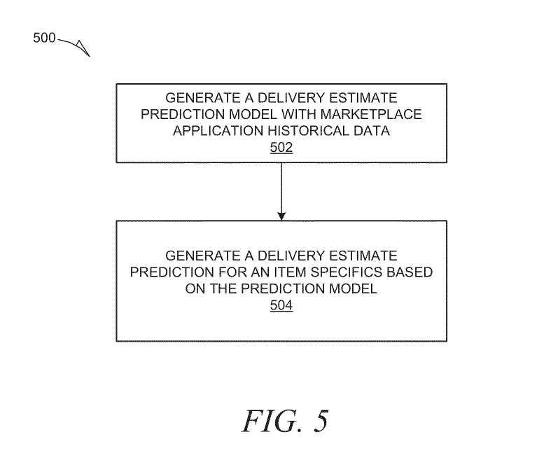

FIG. 5 is a flow diagram illustrating an example embodiment of a method 500 for generating a delivery estimate prediction. At 502, a delivery estimate prediction model with marketplace application historical data is generated. At 504, a delivery estimate prediction is generated for an item specifics based on the prediction model.

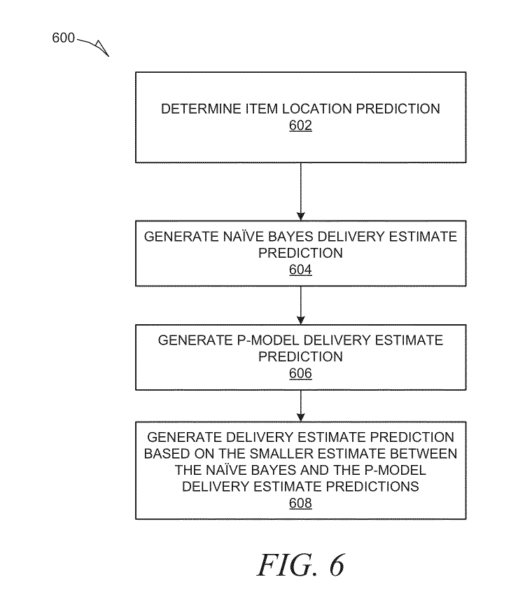

FIG. 6 is a flow diagram illustrating another example embodiment of a method 600 for generating a delivery estimate prediction based on item specifics. At 602, the item location is predicted. At 604, a Naïve Bayes delivery estimate prediction is generated. At 606, a P model delivery estimate prediction is generated. At 608, a delivery estimate prediction is generated based on the smaller estimate between the Naïve Bayes delivery estimate and the P model delivery estimate.

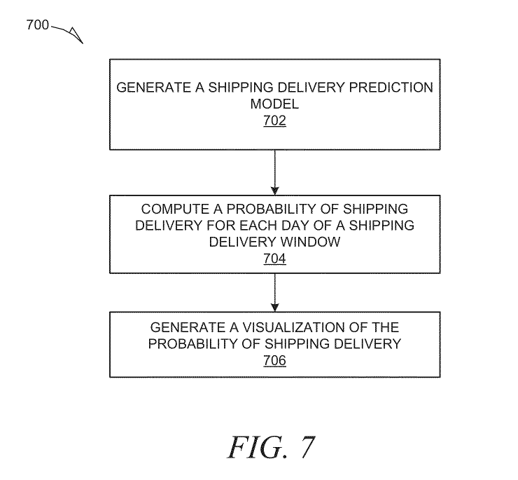

FIG. 7 is a flow diagram illustrating an example embodiment of a method 700 for generating a visualization of delivery estimate prediction. At 702, a shipping delivery prediction model is generated. At 704, a probability of shipping delivery for each day of a shipping delivery window is computed. At 706, a visualization of the probability of shipping delivery is generated.

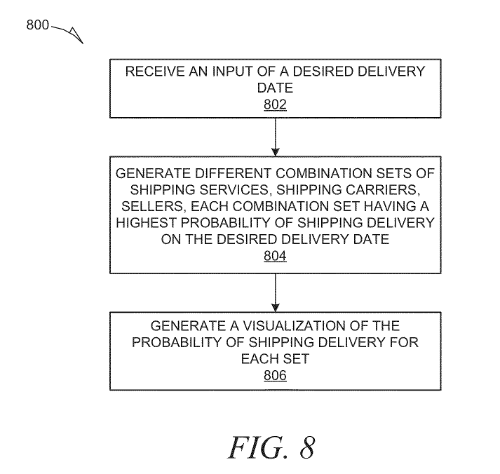

FIG. 8 is a flow diagram illustrating an example embodiment of a method 800 for generating a visualization of delivery estimate prediction for each set of shipping services, carriers, or sellers. At 802, an input of a desired delivery data is received. At 804, different combination sets of shipping services, shipping carriers, sellers are generated. A probability delivery date may be generated for each combination. In one example embodiment, the combination with the highest probability of shipping delivery on a desired delivery date may be identified. At 806, a visualization of probability of shipping delivery for one or more combination set may be generated.

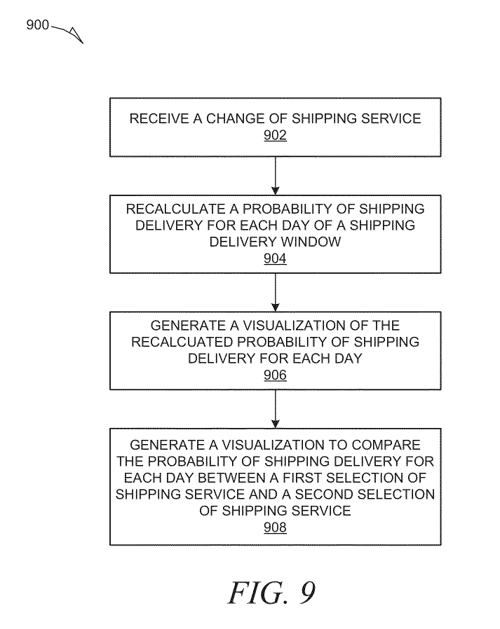

FIG. 9 is a flow diagram illustrating an example embodiment of a method 900 for generating a visualization of a comparison of delivery estimate predictions for one or more shipping services, carriers, or sellers. At 902, a change of shipping service is received. At 904, a probability of shipping delivery for each day of a shipping delivery window is recalculated based on the change in shipping service. At 908, a visualization of the recalculated probability of shipping delivery for each day is generated. At 908, a visualization to compare the probability of shipping delivery for each day between a first selection of shipping service and a second selection of shipping service is generated.

In another embodiment, the delivery estimate prediction application 234 includes a buyer module, a seller module, a transaction item module, a marketplace transaction history module, a shipping service provider module, a seasonal module, and a personal delivery estimate computation engine.

The buyer module determines a shipping delivery geographic location using the buyer information from the marketplace application 120. For example, the buyer information may include a name, a physical address (i.e., street name/post office box and zip code), an email address, and a telephone number. In particular, the buyer information may also include a mailing address. For example, the buyer may wish to have the item ordered on the online marketplace shipped to a particular delivery address or location. The buyer information may be stored in a storage device, such as the database 126.

The seller module determines a shipping origin geographic location using the seller information from the marketplace application 120. For example, the seller information may include a name, a physical address (i.e., street name/post office box and zip code), an email address, and a telephone number. In particular, the seller information may also include an origin address. For example, the seller may ship the item from a warehouse or a location other than the seller address registered on the online marketplace. The seller information may be stored in a storage device, such as the database 126.

The transaction item module identifies the item to be shipped and specifications of a shipping package based on the identified item. For example, the transaction item module may identify an item with its name, weight, physical dimensions, and model number. The specifications of the shipping package may include a weigh of the shipping package and physical dimensions of the shipping package to fit the item. The specifications of the shipping package may be determined or extrapolated from the identification of the item. For example, if the item to be shipped is a printer, the dimensions and weight of the printer may be obtained from the model number. The dimensions of the shipping container may then be obtained from the dimensions and weight of the printer.

In another embodiment, the seller may be prompted to provide the transaction item module with the specifications of the shipping package.

In yet another embodiment, the physical specifications of the item may include, for example, physical dimensions (e.g., height, width, length, and weight). Physical dimensions may be deduced or derived, for example, from a picture or video of the item taken with a mobile device of the seller.

The marketplace transaction history module identifies historical delivery times (e.g., elapsed time from order placed to item received) using the historical transactions of buyers and sellers in the marketplace application 120 of the item and the historical transactions of the seller in the marketplace application 120. The historical transactions of buyers and sellers in the marketplace application 120 may be stored in a storage device, such as database 126.

The historical transactions of buyers and sellers may include buyer information, seller information, origin address, shipping address, items shipped, shipping service provider, shipping and handling elapsed time (e.g., how long did it take from the time the buyer placed the order to the time the item was delivered to the buyer), handling time (e.g., how long it took the seller to deposit the item with the shipping carrier), shipping duration (e.g., how long was the time in transit with the shipping carrier), and date and time of delivery.

In another embodiment, the marketplace transaction history module identifies historical transactions of buyers having a shipping origin within a first threshold distance of the shipping origin of the buyer, and sellers having a shipping destination within a second threshold distance of the shipping destination of the seller, for items having specifications similar to a specification of the item. In other words, the marketplace transaction history module identifies previous transactions involving similar items that were shipped from a similar geographic source location to a similar geographic destination location. The marketplace transaction history module then computes an average shipping and handling time using the identified historical transactions. To refine the estimate, the marketplace transaction history module may further identify similar shipping carriers with similar selected shipping services.

In another embodiment, the marketplace transaction history module computes an average handling time for the seller to ship the item using the historical delivery times. The handling time comprises a time elapsed from when an order is received by the seller from the online marketplace to when the item is shipped by the seller.

In yet another embodiment, the historical transactions of the seller include seller ratings, seller feedbacks, and a number of items shipped on the online marketplace from the seller.

The shipping service provider module determines a shipping carrier delivery estimate using the seller information, the buyer information, specifications of the shipping package, and a selected shipping service. For example, given the origin address, the destination address, and the selected shipping service (e.g., first class, expedited delivery, rush, priority, next day, ground, express, and so forth), the shipping service provider module communicates with the corresponding shipping service provider to obtain a delivery estimate based on the above input. For example, the shipping service provider may determine that it takes 5-7 days to ship the item from a first location to a second location. It should be noted that the shipping carrier delivery estimate does not include the handling time: the elapsed time between the time an order is received by the seller and the time the item is provided to (or picked up by) the shipping service provider for shipping by the seller. In another embodiment, the handling time may include the elapsed time between the time an order is received and the time the shipping service provider is notified to pick up the item.

The seasonal module determines a shipping season and any other external factors affecting a shipping duration of the item. For example, weather and holidays may affect shipping time. Other factors may include employees' strikes, power outages, fuel shortages, and so forth.

The personal delivery estimate computation engine generates the personalized delivery time estimate for the buyer using the shipping delivery geographic location, the shipping origin geographic location, historical delivery times, the shipping carrier delivery estimate, the shipping season, and external factors. The personalized delivery time estimate comprises a range of dates.

For example, the personal delivery estimate computation engine may determine how long it typically takes for a similar item to be shipped from a seller to a buyer with similar zip code, similar shipping carrier, and similar shipping carrier service.

In another example, the personal delivery estimate computation engine may look at prior transactions from the seller to determine on average how long it typically takes for the seller to prepare an item for shipping. For example, it may take, on average, 1.5 days for a seller to ship the item from the time the order has been received.

In another embodiment, a further analysis may be performed based on the type of item being shipped. For example, some items may take a longer time to prepare for shipping (such as fragile items since they require more packaging and preparation).

In another embodiment, different weights may be assigned to the shipping delivery geographic location, the shipping origin geographic location, historical delivery estimates, the shipping carrier delivery estimate, the shipping season, and external factors to compute the personalized delivery time estimate for the buyer.

For example, the historical delivery estimates may carry a heavier weight in computing the personalized delivery time estimate for the buyer than the shipping carrier delivery estimate.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein, as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses that connect the modules). In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

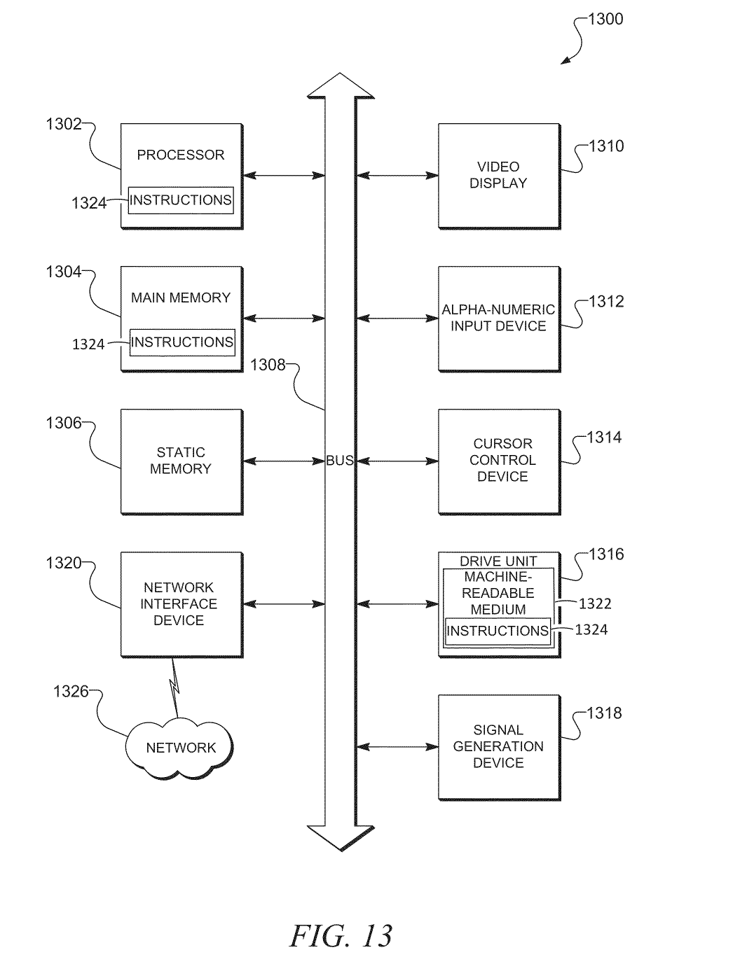

FIG. 13 shows a diagrammatic representation of a machine in the example form of a computer system 1300 within which a set of instructions may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1300 includes a processor 1302 (e.g., a central processing unit (CPU), a graphics processing unit (GPU) or both), a main memory 1304 and a static memory 1306, which communicate with each other via a bus 1308. The computer system 1300 may further include a video display unit 1310 (e.g., a liquid crystal display (LCD) or a cathode ray tube (CRT)). The computer system 1300 also includes an alphanumeric input device 1312 (e.g., a keyboard), a UI navigation device 1314 (e.g., a mouse), a disk drive unit 1316, a signal generation device 1318 (e.g., a speaker) and a network interface device 1320.

The disk drive unit 1316 includes a machine-readable medium 1322 on which is stored one or more sets of instructions and data structures (e.g., software 1324) embodying or utilized by any one or more of the methodologies or functions described herein. The software 1324 may also reside, completely or at least partially, within the main memory 1304 and/or within the processor 1302 during execution thereof by the computer system 1300, with the main memory 1304 and the processor 1302 also constituting machine-readable media 1322.

The software 1324 may further be transmitted or received over a network 1326 via the network interface device 1320 utilizing any one of a number of well-known transfer protocols (e.g., HTTP).

While the machine-readable medium 1322 is shown in an example embodiment to be a single medium, the term “machine-readable medium” should be taken to include a single medium or multiple media (e.g., a centralized or distributed database, and/or associated caches and servers) that stores the one or more sets of instructions. The term “machine-readable medium” shall also be taken to include any medium that is capable of storing, encoding or carrying a set of instructions for execution by the machine and that cause the machine to perform any one or more of the methodologies of the present description or that is capable of storing, encoding or carrying data structures utilized by or associated with such a set of instructions. The term “machine-readable medium” shall accordingly be taken to include, but not be limited to, solid-state memories, optical media, and magnetic media. Specific examples of machine-readable storage media include non-volatile memory, including by way of example semiconductor memory devices (e.g., erasable programmable read-only memory (EPROM), electrically erasable programmable read-only memory (EEPROM), and flash memory devices); magnetic disks such as internal hard disks and removable disks; magneto-optical disks; and CD-ROM and DVD-ROM disks.

What is claimed is:

1. A system comprising:
a delivery estimate model module configured to generate a first delivery estimate prediction model and a second delivery estimate prediction model using historical data from an online marketplace;
a storage device comprising the historical data from the online marketplace; and
a delivery estimate prediction module configured to:
determine transaction information related to an item listed in the online marketplace;
calculate a first time estimate by applying the transaction information to the first delivery estimate prediction model;
calculate a second time estimate by applying the transaction information to the second delivery estimate prediction model; and
generate a delivery time estimate based on the lowest of the first time estimate and the second time estimate.

2. The system of claim 1, wherein the transaction information comprises a seller identification, a method of shipment, a shipping origin location of the item, a shipping destination location of the item, an order date and time of the item, and a price of the item, wherein the delivery time estimate represents the maximum number of business days for shipping and handling.

3. The system of claim 1, wherein the historical data comprises seller identifications, corresponding methods of shipment, corresponding shipping origin location of items, corresponding shipping destination locations of items, corresponding order dates and times of items, and corresponding prices of items.

4. The system of claim 1, wherein the delivery estimate prediction module further comprises:
an item location prediction module configured to predict a shipping origin location of the item based on an identification of the seller.

5. The system of claim 1, wherein the first delivery estimate prediction model predicts the lowest number of business days x such that a shipping origin location of the item is known, a seller of the item has at least one transaction with tracking information during a training period of the first delivery estimate prediction model, the seller has shipped within y business days at least a fraction p of the time during the training period, a combination of a shipping method, a corresponding three-digit zip code origin prefix, a corresponding three-digit zip code destination prefix resulted in at most z days in shipping time at least a fraction p of the time during the training period, wherein x is the sum of y and z, and p is a model parameter specified individually for each possible value of x.

6. The system of claim 1, wherein the second delivery estimate prediction model predicts the total handling and shipping time using a Naïve Bayes algorithm trained with variables from an identification of the seller, a shipment method, a distance between an origin and destination zip codes, the first three digits of the destination zip code, an expected payment hour of day, an expected payment date, a leaf category identifier of the item, and a price of the item, the total handling and shipping time is the lowest number of days x such that the confidence that the item arrives within x days from payment is greater or equal than s times the confidence that the item will arrive later, wherein s is a parameter defined individually for each possible value of x.

7. The system of claim 1, wherein the storage device is configured to store data for the first and second delivery estimate prediction models as a series of key value pairs.

8. The system of claim 1, wherein the delivery estimate prediction module is configured to calculate the first time estimate using a p model algorithm before the second time estimate using a Naïve Bayes algorithm.

9. The system of claim 1, wherein the delivery estimate prediction module further comprises a multiple additive regression tree module further configured to:
separate data related to a third delivery estimate prediction model into two data sets comprising a training data set and a validation data set;
use the training data for training the third delivery estimate prediction model;
evaluate the third delivery estimate prediction model using the validation data set after adding each decision tree to generate a validation error;
iterate the use of the training data and the evaluation of the third delivery estimate prediction model until the validation error stops decreasing or starts increasing; and
calculate a third time estimate by applying the transaction information to the third delivery estimate prediction model.

10. The system of claim 1, further comprising:
a graphical visualization module configured to generate a graphical display of delivery dates and corresponding delivery probabilities.

11. A method comprising:
generating, using a processor of computer, a first delivery estimate prediction model and a second delivery estimate prediction model using historical data from an online marketplace;
storing the historical data from the online marketplace in a storage device;
determining transaction information related to an item listed in the online marketplace;
calculating a first time estimate by applying the transaction information to the first delivery estimate prediction model;
calculating a second time estimate by applying the transaction information to the second delivery estimate prediction model; and
generating a delivery time estimate based on the lowest of the first time estimate and the second time estimate.

12. The method of claim 11, wherein the transaction information comprises a seller identification, a method of shipment, a shipping origin location of the item, a shipping destination location of the item, an order date and time of the item, and a price of the item, wherein the delivery time estimate represents the maximum number of business days for shipping and handling.

13. The method of claim 11, wherein the historical data comprises seller identifications, corresponding methods of shipment, corresponding shipping origin location of items, corresponding shipping destination locations of items, corresponding order dates and times of items, and corresponding prices of items.

14. The method of claim 11, further comprising:
predicting a shipping origin location of the item based on an identification of the seller.

15. The method of claim 11, wherein the first delivery estimate prediction model predicts the lowest number of business days x such that a shipping origin location of the item is known, a seller of the item has at least one transaction with tracking information during a training period of the first delivery estimate prediction model, the seller has shipped within y business days at least a fraction p of the time during the training period, a combination of a shipping method, a corresponding three-digit zip code origin prefix, a corresponding three-digit zip code destination prefix resulted in at most z days in shipping time at least a fraction p of the time during the training period, wherein x is the sum of y and z, and p is a model parameter specified individually for each possible value of x.

16. The method of claim 11, wherein the second delivery estimate prediction model predicts the total handling and shipping time using a Naïve Bayes algorithm trained with variables from an identification of the seller, a shipment method, a distance between an origin and destination zip codes, the first three digits of the destination zip code, an expected payment hour of day, an expected payment date, a leaf category identifier of the item, and a price of the item, the total handling and shipping time is the lowest number of days x such that the confidence that the item arrives within x days from payment is greater or equal than s times the confidence that the item will arrive later, wherein s is a parameter defined individually for each possible value of x.

17. The method of claim 11, further comprising:
storing data for the first and second delivery estimate prediction models as a series of key value pairs in the storage device; and
calculating the first time estimate using a p model algorithm before the second time estimate using a Naïve Bayes algorithm.

18. The method of claim 11, further comprising:
separating data related to a third delivery estimate prediction model into two data sets comprising a training data set and a validation data set;
using the training data for training the third delivery estimate prediction model;
evaluating the third delivery estimate prediction model using the validation data set after adding each decision tree to generate a validation error;
iterating the use of the training data and the evaluation of the third delivery estimate prediction model until the validation error stops decreasing or starts increasing; and
calculating a third time estimate by applying the transaction information to the third delivery estimate prediction model.

19. The method of claim 11, further comprising:
generating a graphical display of delivery dates and corresponding delivery probabilities based on the delivery time estimate.

20. A non-transitory computer-readable storage medium storing a set of instructions that, when executed by a processor, cause the processor to perform operations, comprising:
generating a first delivery estimate prediction model and a second delivery estimate prediction model using historical data from an online marketplace;
storing the historical data from the online marketplace in a storage device;
determining transaction information related to an item listed in the online marketplace;
calculating a first time estimate by applying the transaction information to the first delivery estimate prediction model;
calculating a second time estimate by applying the transaction information to the second delivery estimate prediction model; and
generating a delivery time estimate based on the lowest of the first time estimate and the second time estimate.
